(19) United States
(12) Patent Application Publication
(10) Pub. No.: US 2024/0243295 A1
(43) Pub. Date: Jul. 18, 2024

(54) Method of Preventing Corrosion of a Current Collector of a Battery and an Anti-Corrosion Layer Thereof

(71) Applicant: National Taiwan University of Science and Technology, Taipei (TW)

(72) Inventors: Bing-Joe Hwang, Taipei (TW); Teshager Mekonnen Tekaligne, Taipei (TW); Sheng-Chiang Yang, Taipei (TW); Wei-Nien Su, Taipei (TW)

(21) Appl. No.: 18/319,573

(22) Filed: May 18, 2023

(30) Foreign Application Priority Data
Jan. 18, 2023 (TW) 112102179

(51) Int. Cl. H01M 4/62; C25D 11/00; H01M 10/44

(52) U.S. Cl. CPC H01M 4/628; C25D 11/00; H01M 10/446

(57) ABSTRACT

A method of preventing corrosion of a battery current collector, comprising the steps of: providing an electrochemical battery comprising at least an anode, a cathode, and an electrolyte between the anode and the cathode; wherein: the cathode comprises a metal current collector and the electrolyte comprises a metal chelator, a negatively charged metal salt, and a solvent; performing charge/discharge on the electrochemical battery; wherein, the metal chelator in the electrolyte and the metal ions of the metal current collector, or the metal chelator in the electrolyte is co-chelated with both the metal ions of the metal current collector and the negative charge of the negatively charged metal salt to form an anti-corrosion layer on the metal current collector; by adding a chelating electrolyte as a protective layer, the metal current collector can be protected from electrolyte corrosion and the electrodes maintain high conductivity, thereby improving the efficiency of the battery.

### FIELD OF INVENTION

The present invention provides a method of preventing corrosion, in particular for the battery current collector, and the anti-corrosion layer thereof.

### BACKGROUND OF THE INVENTION

Aluminum foil and copper foil are commonly used in commercial applications as the electrode's current collector for electrochemical batteries due to their high electrical conductivity, low cost, and low density.

The electrolyte in today's commercial batteries contains a large number of organic solvents, and when it is in the event of a short circuit or overcharging, the combustion of organic solvents can pose a significant safety risk. Therefore, batteries are gradually moving towards the use of water-based electrolytes, which consist mainly of harmless water and can effectively avoid the risk of organic electrolyte combustion, and are also more environmentally friendly.

However, although aqueous electrolytes are safe and environmentally friendly, the cathode current collectors such as aluminum foil and copper foil can be severely chemically corroded in aqueous electrolytes, leading to structural degradation and further catastrophic battery failure.

How to make aluminum foil and copper foil have better resistance in aqueous electrolytes with higher safety is an urgent problem to be solved. Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the present problem that the aluminum foil and copper foil are severely chemically corroded in aqueous electrolytes, resulting in structural degradation and causing further catastrophic battery failure, the present invention provides a battery current collector corrosion prevention method comprising the steps of: providing an electrochemical battery comprising at least an anode, a cathode, and an electrolyte between the anode and the cathode; wherein: the cathode comprises a metal current collector, the electrolyte comprises a metal chelator, a negatively charged metal salt, and a solvent; the metal chelator in the electrolyte is chelated with the metal ions of the metal current collector, or the metal chelator in the electrolyte is chelated with both the metal ions of the metal current collector and the negative charge of the negatively charged metal salt, to form an anti-corrosion layer on the metal current collector.

The present invention also provides an anti-corrosion layer obtained by the aforementioned method.

In accordance, the present invention has the following beneficial effects and advantages:

The present invention protects aluminum foil or copper foil current collectors from attack by aqueous electrolytes by using the electrolyte containing the metal chelator as a corrosion inhibitor in the passivation process of aluminum foil, thereby improving battery efficiency.

The metal chelator used in the present invention, one of the preferred embodiments is phthalocyanine which is a macrocyclic compound, the central cavity can be occupied by more than 70 kinds of metal elements and some non-metallic elements, the present invention is based on the chelating effect of the metal chelator, so that the metal chelator, the metal layer of the aluminum foil or copper foil current collectors, and the negative charge components contained in the electrolyte can be formed as an insoluble chelate (or complex), so that the electrochemical properties will not be limited by the corrosion and can improve the overall performance. This corrosion inhibition technology can also be applied to other batteries or electrochemical systems such as copper foil, nickel foil, indium foil, stainless steel sheet, titanium sheet, etc.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1A is a flow chart of the steps illustrating the method of preventing corrosion of the metal current collector of the present invention for a electrochemical battery;

FIG. 1B is a compared illustration of the comparative example (on the left) and the present invention (on the right) of the mechanism for Pc interacting with the metal current collector.

FIG. 2 is a schematic diagram of the structure of the fluorine chelation process of the metal chelator with the metal of the metal current collector and the negatively charged metal salt of the present invention;

FIGS. 3A and 3B are the results of the Potentiodynamic Polarisation Curve and the current density and corrosion rate for the embodiment of the present invention and the comparative example;

FIGS. 4A˜4D are the scanning electron microscope images of the metal current collector at different magnifications of the comparative example and the embodiment of the present invention;

FIGS. 5A and 5B are the Focused Ion Beam (FIB) cross-sectional microscope investigation and surface pattern observation of the metal current collector of the comparative example and the embodiment of the present invention, respectively;

FIGS. 6A and 6B are the X-ray photoelectron spectra images of the metal current collector of the comparative example and the embodiment of the present invention, respectively;

FIGS. 7A˜7D are the electrical performance of an aqueous electrolyte zinc battery in the charging and discharging cycle of the comparative example and the embodiment of the present invention; and

FIGS. 8A˜8D are the electrical performance of a lithium battery with an organic electrolyte in the charging and discharging cycle of the comparative example and the embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

### <Method of Preventing Corrosion of Battery Current Collector>

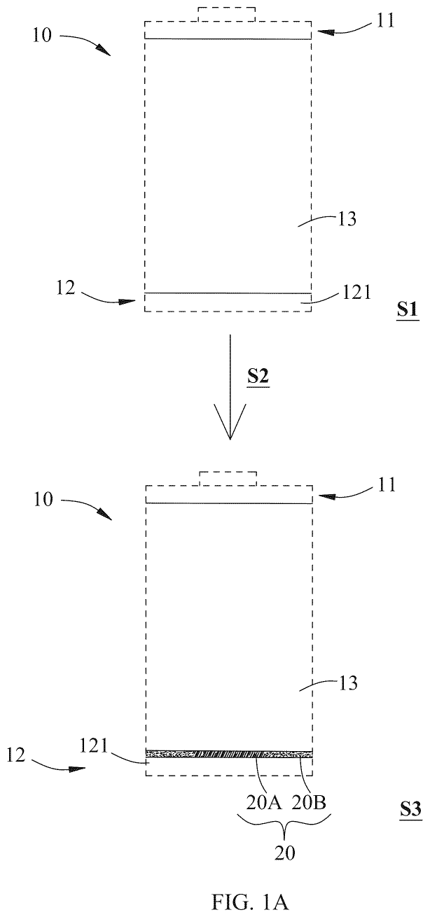

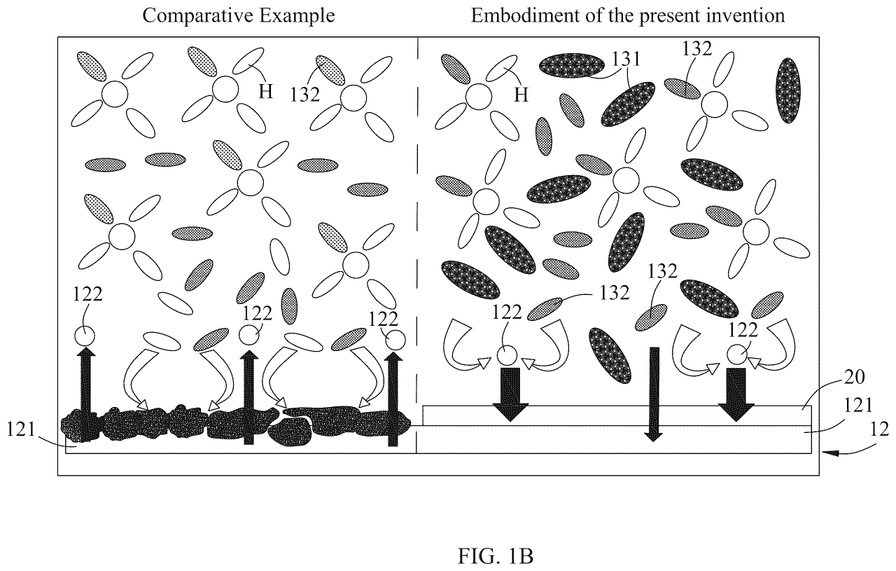

Referring to FIGS. 1A and 1B, the present invention provides a method of preventing corrosion of a battery current collector, comprising the steps of:
Step 1) providing an electrochemical battery 10 comprising at least an anode 11, a cathode 12, and an electrolyte 13 between the anode 11 and the cathode 12; the cathode 12 comprising a metal current collector 121, the electrolyte 13 comprising a metal chelator 131, a negatively charged metal salt 132, and a solvent, the solvent comprising water and/or an organic solvent; wherein: the said negatively charged metal salt 132 also refers to a metal salt carried with negative charge which has affinity to the metal current collector 121 carried with positive charge;
Step 2) performing at least one charge/discharge cycle on the electrochemical battery 10; and
Step 3) the metal chelator 131 in the electrolyte 13 is chelated with metal ions 122 dissolved from or generated from the metal current collector 121, or the metal chelator 131 in the electrolyte 13 is chelated with both the metal ions 122 of the metal current collector 121 and the negative charge of the negatively charged metal salt 132, to form an anti-corrosion layer 20 on the metal current collector 121. The anti-corrosion layer 20, as shown in FIGS. 1A and 1B, may in some conditions comprise the metal chelator 131 chelated with the metal ions 122 of the metal current collector 121 to form a first anti-corrosion layer 20A, and the metal chelator 131 in the electrolyte 13 chelated with both the metal ions 122 of the metal current collector 121 and the negative charge of the negatively charged metal salt 132 to form a second anti-corrosion layer 20B.

On the left side of the FIG. 1B, it demonstrates a comparative example without adding the metal chelator 131. The H₂O molecular H of the solvent and the negative charge of the negatively charged metal salt 132 attacks the metal current collector 121 and the metal ions 122 keeps dissolving out of from it making severe corrosion of the metal current collector 121. On the other hand, on the right side of the FIG. 1B, the embodiment of the present invention with the metal chelator 131 can chelate with both the metal ions 122 of the metal current collector 121 and the negative charge of the negatively charged metal salt 132 to form the anti-corrosion layer 20 preventing the H₂O molecular H gets into the metal current collector 121 to achieve anti-corrosion.

The aforementioned electrochemical battery 10 comprises a lithium battery, a zinc battery, a sodium battery, a magnesium battery, potassium battery, calcium battery, or an aluminum battery with organic electrolyte or aqueous electrolyte, and in some possible conditions, the electrochemical battery 10 also comprises a separator film provided between the anode 11 and the cathode 12; the anode 11 is any kind of anode material suitable for different electrochemical batteries 10, without limitation herein; the metal current collector 121 of the cathode 12 comprises a copper foil, an aluminum foil, a nickel foil, an indium foil, a stainless steel sheet, or a titanium sheet, and any kind of metal current collector suitable for the electrochemical battery 10.

The metal chelator 131 in the electrolyte 13 is preferably a negatively charged metal chelator, including Phthalocyanine (PC), whose negative charge has an adsorption effect with the positively charged metal ions 122 on the metal current collector 121, so that the metal chelator 131 can actively attach to the metal current collector 121 and chelate its metal ions 122 to form a stable anti-corrosion layer 20.

The negatively charged metal salt 132 also has an affinity for the positively charged metal ions 122 on the metal current collector 121 due to its negative charge, and thus will co-chelate with the metal chelator 131 and the positively charged metal ions 122 on the metal current collector 121, wherein the negatively charged metal salt 132 includes, but is not limited to, the metal salts containing Arsenic (As), Chlorine (CI), Fluorine (F), Bromine (Br), Iodine (I), Antimony (Sb), Selenium (Se), Phosphorus (P), Sulfur (S), Nitrogen (N), Boron (B), Oxygen (O), and/or Carbon (C), such as Lithium, Sodium, Zinc, Magnesium, or Aluminum Salts, such as but not limited to Lithium bis(Trifluoromethanesulphonate)imide (LiTFSI), Lithium Tetrafluoroborate (LiBF₄), Lithium Hexafluoroarsenate (LiAsF₆), Lithium Hexafluorophosphate (LiPF₆), Lithium Tetrafluoroborate (LiDFOB), Lithium Bisfluorosulfonimide (LiFSI), Hexafluorophosphate, Perchlorate, Tetrafluoroborate, Tris(pentafluoroethyl)trifluorophosphate (FAP), Trifluoromethanesulfonate (Triflate), Bis(fluorosulfonyl)imide (FSI), Cyclodifluoromethane-1,1-bis(sulfonyl)imide (DMSI), Cyclo-hexafluoropropane-1,1-bis(sulfonyl)imide (HPSI), Bis(trifluoromethanesulfonyl)imide (TFSI), Bis(perfluoroethanesulfonyl)imide (BETI), Bis(oxalate) borate (BOB), Difluoro(oxalato)borate (DFOB), Bis(fluoromalonato)borate (BFMB), Tetracyanoborate (Bison), Dicyanotriazolate (DCTA), Dicyano-trifluoromethyl-imidazole (TDI), or Dicyano-pentafluoroethyl-imidazole (PDI).

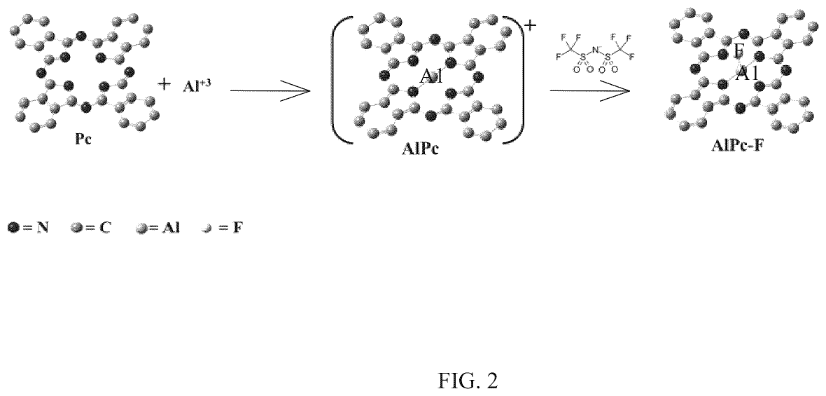

A preferred embodiment of the chelation process described in the preceding Step 3 is shown in FIG. 2, wherein the aluminum foil is used as the metal current collector 121, and the metal chelator 131 with Phthalocyanine (PC) and the Lithium Bis(Trifluoromethanesulphonate)imide (LiTFSI) as the negatively charged metal salt 132 is used as an example for the chelation process.

### <Anti-Corrosion Layer>

As shown in FIGS. 1A˜1B and 2, the present invention also provides an anti-corrosion layer 20 formed on the metal current collector 121 of the electrochemical battery 10 by chelating the metal chelator 131 with the metal of the metal current collector 121 and the fluorine of the negatively charged metal salt 132. The metal current collector 121 generates metallic ions and the metal chelator 131 chelates the metallic ions and further reacts with the negative charge from the negatively charged metal salt 132 and forms AlPc-F chelating compound shown in FIG. 2.

### <Validation Test>

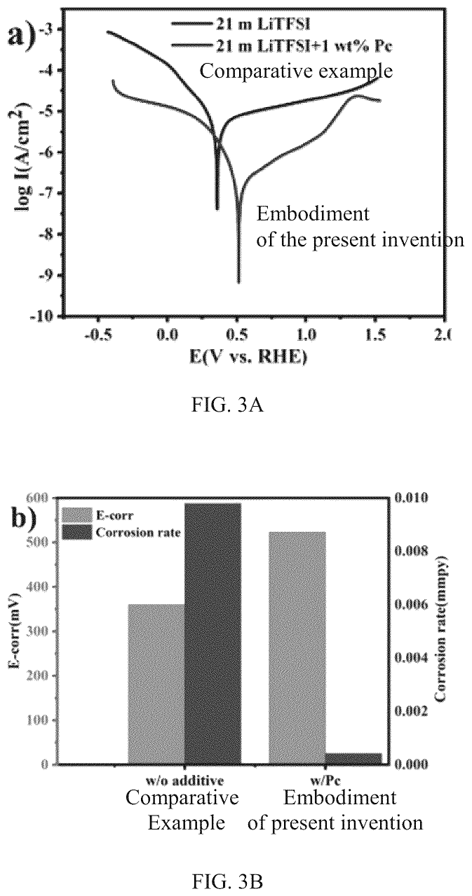

In order to demonstrate that the anti-corrosion layer 20 provided by the present invention is capable of improving the corrosion resistance of the metal current collector 121, the electrochemical battery 10 with the anti-corrosion layer 20 obtained by the method of preventing corrosion of the battery current collector described in the present invention, and a general electrochemical battery without the addition of the metal chelator 131 to the electrolyte 13 will be used as a comparison. Wherein, the electrolyte 13 of the present invention contains a concentration of 21m Lithium Bis(Trifluoromethanesulphonate)imide (LiTFSI) and 1% Phthalocyanine, while the comparative example contains a concentration of 21m Lithium Bis(Trifluoromethanesulphonate)imide (LiTFSI) without additional Phthalocyanine. Referring to FIGS. 3A and 3B and Table 1 below, which show the results of the Potential dynamic Polarisation Curve and the current density and corrosion rate of the embodiment of the present invention and the comparative example. From FIGS. 3A and 3B and Table 1 below, it can be confirmed by the measurement of the potential polarisation that the corrosion potential of the 21m LiTFSI of the comparative example (without Phthalocyanine) is 360.59 mV, which is lower than that of the present invention (with Phthalocyanine addition) of 513.28 mV. The current density is 0.302 mA/cm² of the comparative example and 0.013 mA/cm² of the present invention, respectively, indicating that the addition of Phthalocyanine inhibits the corrosion of the metal current collector. With reference to the embodiment of the present invention showed in FIG. 3A, the electrolyte with 1 wt % of Pc making the electrochemical battery 10 presents a higher corrosion potential (0.51V) which means it has a higher or better corrosion resistance compared with the comparative example whose corrosion potential only 0.32V without adding Pc in electrolyte. The anti-corrosion potential (E-corr) of the present invention is much greater than the comparative example also indicates a profound ability of anti-corrosion. Further calculated by Beta a (mV) and Beta c (mV) of 14.5 mV and 23.1 mV of the comparative example and 16.7 mV and 17.5 mV of the embodiment of the present invention, the corrosion rate shown in FIGS. 3A and 3B of the embodiment is 0.426*10⁻³ and the corrosion rate of the comparative example is 9.88*10⁻³ proving that the present invention has a better corrosion resistance up to 23 times compared to the comparative example.

TABLE 1

| | | Embodiment |
|---|---|---|
| | | of the |
| | Comparative | present |
| | Example | Invention (with |
| | (without | Phthalocyanine |
| | Phthalocyanine | addition) |
| | addition) | 21 m LiTFSI + |
| | 21 m LiTFSI | 1% Pc |
| Corrosion potential (V) | 0.32 | 0.51 |
| Anti-Corrosion Potential (E-corr) mV | 361 | 513 |
| Current Density (Icorr) A/cm² | 0.302 | 0.013 |
| Corrosion Rate (mmpy) | 9.880*10⁻³ | 0.426*10⁻³ |

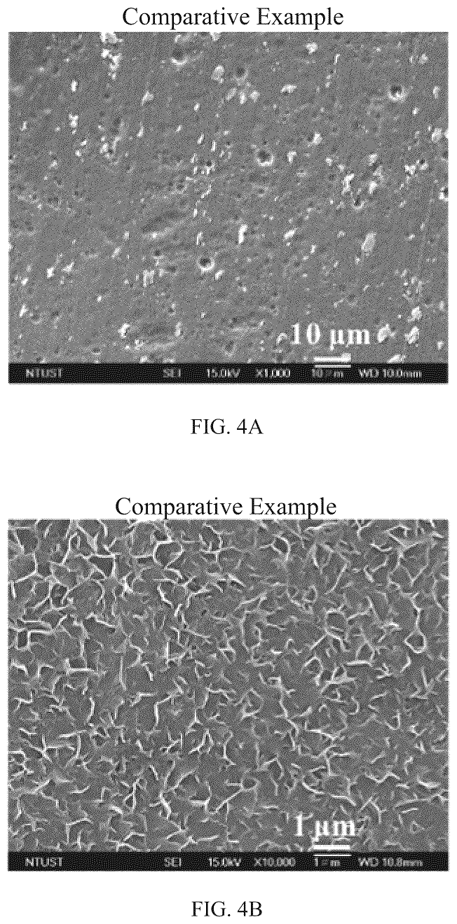

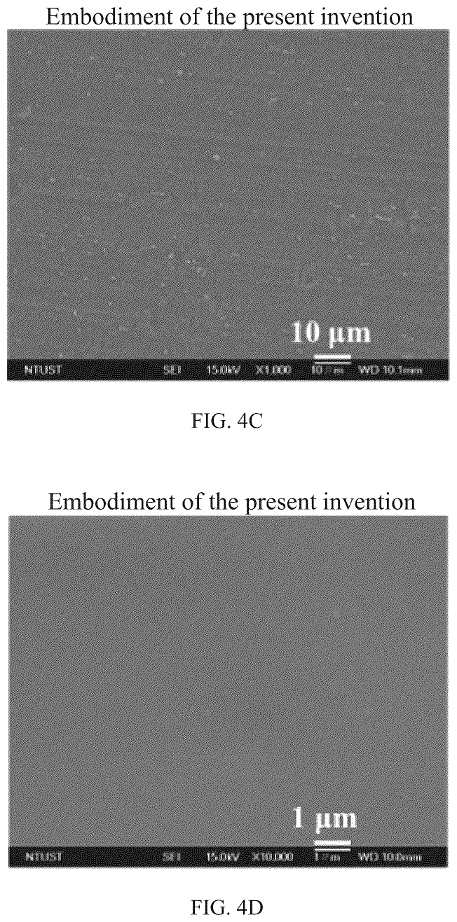

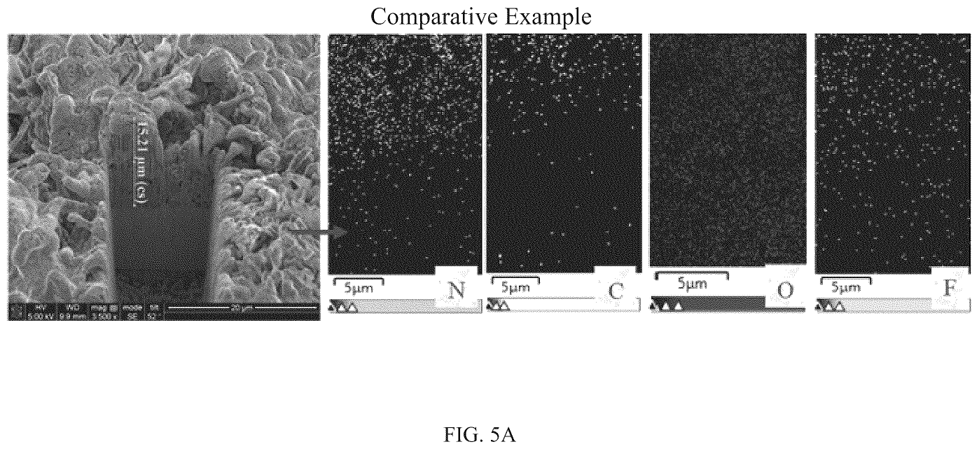

Referring to FIGS. 4A˜4D, wherein FIGS. 4A and 4B are the scanned electron microscope images of the metal current collector at different magnifications of the comparative example, and FIGS. 4C and 4D are the scanned electron microscope images of the metal current collector at different magnifications of the embodiment of the present invention. The surface morphology analysis shows that the surface of the metal current collector with Phthalocyanine added in the present invention is smoother than the surface morphology of the metal current collector without Phthalocyanine added in the comparative example with the electrochemical treatment cycle of charging and discharging, indicating that it has the corrosion inhibiting effect.

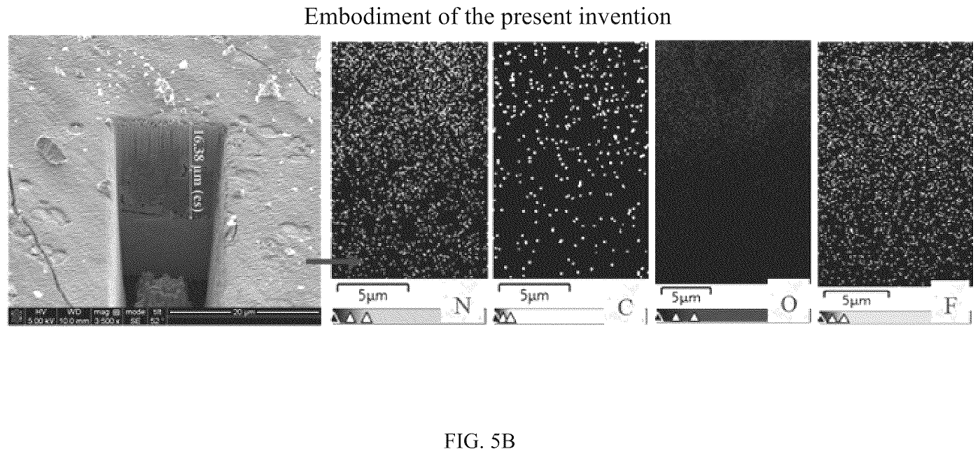

Referring to FIGS. 5A and 5B, which are the Focused Ion Beam (FIB) cross-sectional investigation and the surface pattern observation of the metal current collector of the comparative example and the embodiment of the present invention, respectively. As shown in FIG. 5A, the comparative example has the oxygen atom (O) signal evenly distributed thought out all the cross section into the metal current collector which indicates that there's no any protection for the metal current collector and causing severe corrosion.

From FIGS. 5B, it can be seen that the present invention, especially in the distribution of oxygen atoms, is apparently distributed only in the upper part of the layer and does not enter into the metal current collector layer, indicating that the addition of the Phthalocyanine of the present invention inhibits the corrosion of the metal current collector. Furthermore, in FIG. 5B, the region near the metal current collector of the present invention presents a weaker oxygen signal (compared with the comparative example) and a stronger fluorine (F) signal which indicates less degree of oxidation (—OH) occurred to the surface of the metal current collector for proving corrosion inhibition of the present invention.

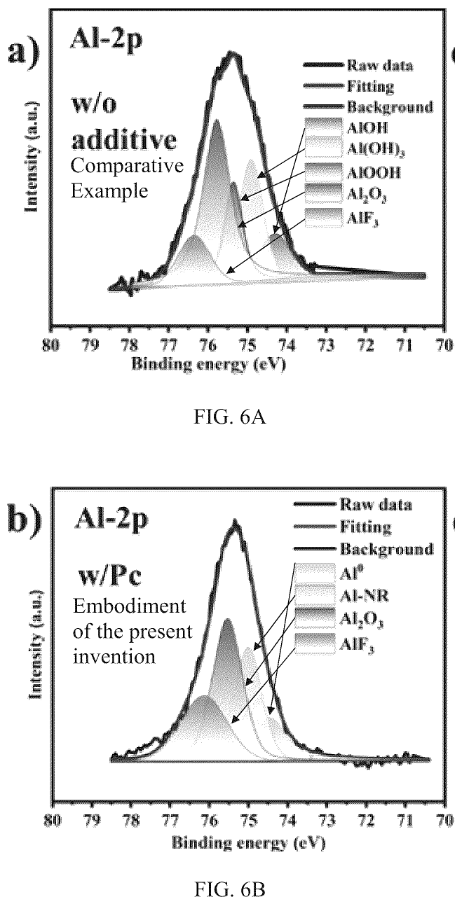

Referring to FIGS. 6A and 6B, which are the X-ray photoelectron spectra of the metal current collector of the comparative example and the embodiment of the present invention, respectively. From the analysis of the surface composition, it can be seen that a number of aluminum hydroxides (AlOH, Al(OH)₃, AlOOH) indicating corrosion are formed on the surface of the metal current collector (aluminum foil) in the comparative example, while no such aluminum hydroxide components are formed in the present invention. Due to the formation of the insoluble chelate complex AlPc-F on the alumina layer, the aluminum foil is protected from electrolytic corrosion by the property of the anti-corrosion layer of Phthalocyanine chelated with metal and fluorine, and effectively prevents oxidation under an electrochemical environment.

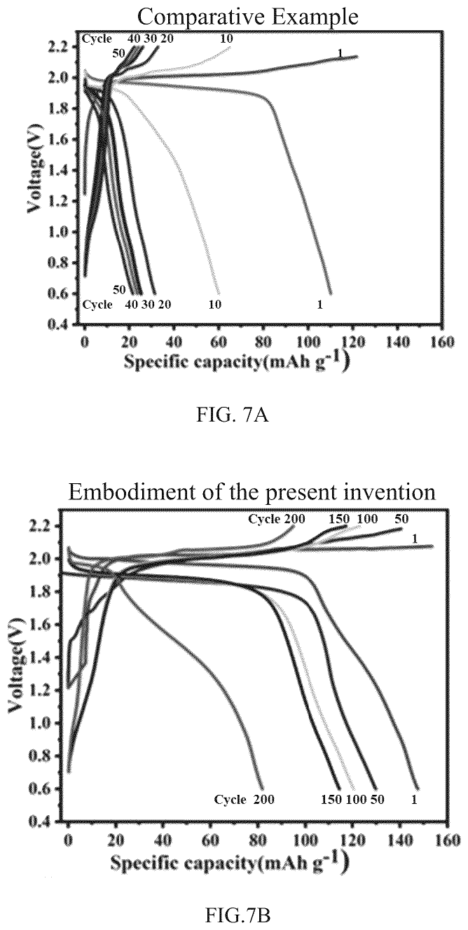

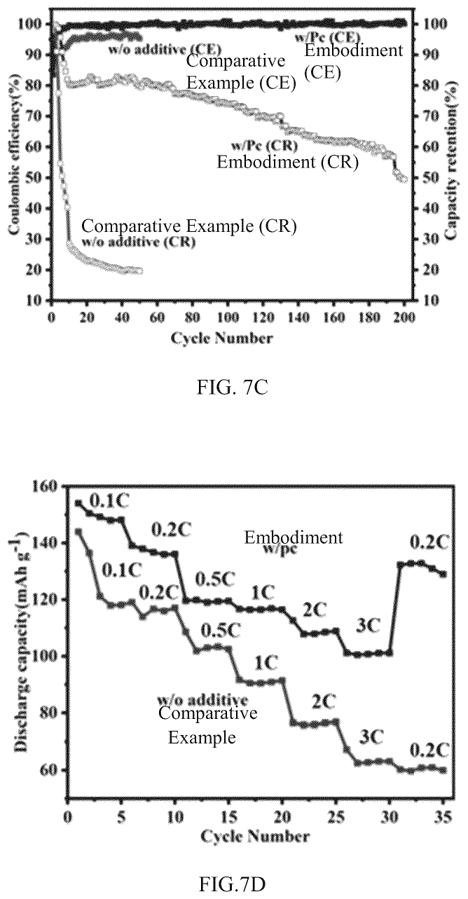

Referring to FIGS. 7A˜7D, which are the electrical performance in the charging and discharging cycle of the aqueous electrolyte system of a zinc battery of the comparative example and the embodiment of the present invention.

In FIGS. 7A and 7B respectively, when charging and discharging the zinc battery, the capacity retention rate still remains at least 80% after 200 cycles for the embodiment of the present invention with Phthalocyanine. The comparative example is much shorter with only 27.57% capacity retention rate. In FIG. 7C, the average coulombic efficiency (ACE) still remains 99.02% even after 200 times of cycle number. On the contrary, the ACE already drops to 93.4% after only 40 times life cycles for the comparative example.

In FIG. 7D, by using different charging and discharging rate under life cycle, the embodiment of the present invention still maintains high capacity under either high charging rate 3C or extreme low charging rate 0.2C. However, the comparative example already present with failed capacity compared to the present invention. As such, the embodiment of the present invention presents with more stable electrical abilities compared to the comparative example.

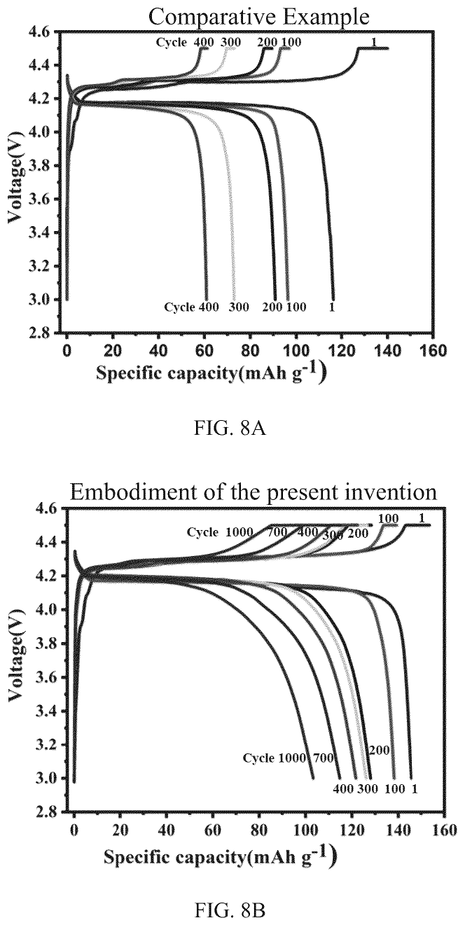

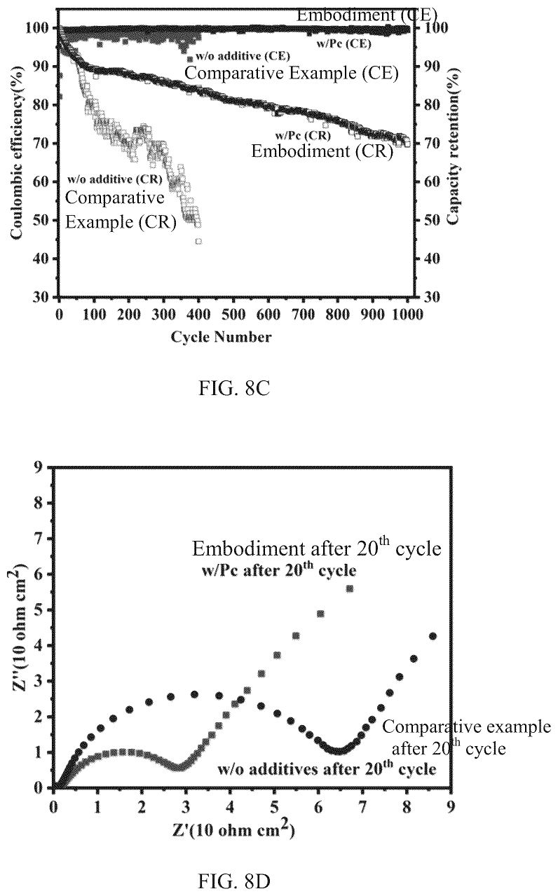

Referring to FIGS. 8A˜8D, which are the electrical performance of the lithium battery with organic electrolyte system in the charging and discharging cycle of the comparative example and the embodiment of the present invention. When charging and discharging the lithium battery, the specific capacity is 103.7 mAhg⁻¹, the capacity retention rate is 70%, and the average coulombic efficiency (ACE) is 99.82% after 1000 cycles with Phthalocyanine at 0.2 C-rate, while the electrolyte without Phthalocyanine has only 60 mAhg⁻¹ and 44.38% capacity retention at the 400th cycle. FIGS. 8A˜8D also indicate the present invention is applicable and could successfully improve all kinds of battery under aqueous electrolyte system or organic electrolyte system.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method of preventing corrosion of a battery current collector, comprising the steps of:
providing an electrochemical battery comprising at least an anode, a cathode, and an electrolyte between the anode and the cathode; wherein: the cathode comprises a metal current collector, the electrolyte comprises a metal chelator, a negatively charged metal salt, and a solvent;
performing at least one charge/discharge cycle on the electrochemical battery; and
the metal chelator in the electrolyte is chelated with the metal ions of the metal current collector, or the metal chelator in the electrolyte is chelated with both the metal ions of the metal current collector and the negative charge of the negatively charged metal salt, to form an anti-corrosion layer on the metal current collector.

2. The method of preventing corrosion of a battery current collector according to claim 1, wherein: the metal current collector of the cathode comprises a copper foil, an aluminum foil, a nickel foil, an indium foil, a stainless steel sheet, or a titanium sheet.

3. The method of preventing corrosion of a battery current collector according to claim 1, wherein: the electrochemical battery comprises a lithium battery, a zinc battery, a sodium battery, a magnesium battery, potassium battery, calcium battery, or an aluminum battery with organic electrolyte or aqueous electrolyte.

4. The method of preventing corrosion of a battery current collector according to claim 1, wherein: the metal chelator in the electrolyte is a negatively charged metal chelator.

5. The method of preventing corrosion of a battery current collector according to claim 2, wherein: the metal chelator in the electrolyte is a negatively charged metal chelator.

6. The method of preventing corrosion of a battery current collector according to claim 3, wherein: the metal chelator in the electrolyte is a negatively charged metal chelator.

7. The method of preventing corrosion of a battery current collector according to claim 4, wherein: the metal chelator comprises Phthalocyanine.

8. The method of preventing corrosion of a battery current collector according to claim 5, wherein: the metal chelator comprises Phthalocyanine.

9. The method of preventing corrosion of a battery current collector according to claim 6, wherein: the metal chelator comprises Phthalocyanine.

10. The method of preventing corrosion of a battery current collector according to claim 1, wherein: the negatively charged metal salt comprises a metal salts containing Arsenic, Chlorine, Fluorine, Bromine, Iodine, Antimony, Selenium, Phosphorus, Sulfur, Nitrogen, Boron, Oxygen, and/or Carbon.

11. The method of preventing corrosion of a battery current collector according to claim 2, wherein: the negatively charged metal salt comprises a metal salts containing Arsenic, Chlorine, Fluorine, Bromine, Iodine, Antimony, Selenium, Phosphorus, Sulfur, Nitrogen, Boron, Oxygen, and/or Carbon.

12. The method of preventing corrosion of a battery current collector according to claim 3, wherein: the negatively charged metal salt comprises a metal salts containing Arsenic, Chlorine, Fluorine, Phosphorus, Sulfur, Nitrogen, Boron, Oxygen, and/or Carbon.

13. The method of preventing corrosion of a battery current collector according to claim 10, wherein: the metal salt comprises Lithium, Sodium, Zinc, Magnesium, or Aluminum Salts.

14. The method of preventing corrosion of a battery current collector according to claim 11, wherein: the metal salt comprises Lithium, Sodium, Zinc, Magnesium, or Aluminum Salts.

15. The method of preventing corrosion of a battery current collector according to claim 12, wherein: the metal salt comprises Lithium, Sodium, Zinc, Magnesium, or Aluminum Salts.

16. The method of preventing corrosion of a battery current collector according to claim 10, wherein: the metal salt comprises Lithium bis(Trifluoromethanesulphonate)imide, Lithium Tetrafluoroborate, Lithium Hexafluoroarsenate, Lithium Hexafluorophosphate, Lithium Tetrafluoroborate, Lithium Bisfluorosulfonimide, Hexafluorophosphate, Perchlorate, Tetrafluoroborate, Tris(pentafluoroethyl)trifluorophosphate, Trifluoromethanesulfonate (Triflate), Bis(fluorosulfonyl)imide, Cyclodifluoromethane-1,1-bis(sulfonyl)imide, Cyclo-hexafluoropropane-1,1-bis(sulfonyl)imide, Bis(trifluoromethanesulfonyl)imide, Bis(perfluoroethanesulfonyl)imide, Bis(oxalate) borate, Difluoro(oxalato)borate, Bis(fluoromalonato)borate, Tetracyanoborate, Dicyanotriazolate, Dicyano-trifluoromethyl-imidazole, or Dicyano-pentafluoroethyl-imidazole.

17. The method of preventing corrosion of a battery current collector according to claim 11, wherein: the metal salt comprises Lithium bis(Trifluoromethanesulphonate)imide, Lithium Tetrafluoroborate, Lithium Hexafluoroarsenate, Lithium Hexafluorophosphate, Lithium Tetrafluoroborate, Lithium Bisfluorosulfonimide, Hexafluorophosphate, Perchlorate, Tetrafluoroborate, Tris(pentafluoroethyl)trifluorophosphate, Trifluoromethanesulfonate (Triflate), Bis(fluorosulfonyl)imide, Cyclodifluoromethane-1,1-bis(sulfonyl)imide, Cyclo-hexafluoropropane-1,1-bis(sulfonyl)imide, Bis(trifluoromethanesulfonyl)imide, Bis(perfluoroethanesulfonyl)imide, Bis(oxalate) borate, Difluoro(oxalato)borate, Bis(fluoromalonato)borate, Tetracyanoborate, Dicyanotriazolate, Dicyano-trifluoromethyl-imidazole, or Dicyano-pentafluoroethyl-imidazole.

18. The method of preventing corrosion of a battery current collector according to claim 12, wherein: the metal salt comprises Lithium bis(Trifluoromethanesulphonate)imide, Lithium Tetrafluoroborate, Lithium Hexafluoroarsenate, Lithium Hexafluorophosphate, Lithium Tetrafluoroborate, Lithium Bisfluorosulfonimide, Hexafluorophosphate, Perchlorate, Tetrafluoroborate, Tris(pentafluoroethyl)trifluorophosphate, Trifluoromethanesulfonate (Triflate), Bis(fluorosulfonyl)imide, Cyclodifluoromethane-1,1-bis(sulfonyl)imide, Cyclo-hexafluoropropane-1,1-bis(sulfonyl)imide, Bis(trifluoromethanesulfonyl)imide, Bis(perfluoroethanesulfonyl)imide, Bis(oxalate) borate, Difluoro(oxalato)borate, Bis(fluoromalonato)borate, Tetracyanoborate, Dicyanotriazolate, Dicyano-trifluoromethyl-imidazole, or Dicyano-pentafluoroethyl-imidazole.

19. An anti-corrosion layer for the battery current collector, which is obtained by using the method of preventing corrosion of a battery current collector as described in any of claim 1.
